(19) United States
(12) Patent Application Publication
(10) Pub. No.: US 2004/0049768 A1
(43) Pub. Date: Mar. 11, 2004

(54) Method and program for compiling processing, and computer-readable medium recoding the program thereof

(75) Inventors: Manabu Matsuyama, Kawasaki (JP); Tadashi Nakahira, Kawasaki (JP); Kaname Mita, Shizuoka (JP); Taisuke Tahara, Shizuoka (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/651,898

(22) Filed: Aug. 29, 2003

(30) Foreign Application Priority Data
Sep. 9, 2002 (JP) 2002-262936

(51) Int. Cl. G06F 9/45

(52) U.S. Cl. 717/141; 717/151

(57) ABSTRACT

According to the present invention, the compiler inputs a plurality of pieces of source data composing a large-scale program on basis of an user-designated information, subjects the source data to syntax analysis, and analyzes attributes of a relation between caller (parent procedure) and callee (child procedure) in the source data from the result of the syntax analysis and registers the attribute in a data table. Then, if the the callee is not registered in the data table, the compiler marks the attributes of the caller procedure with “optimization unnecessary” and then optimizes other procedures excluding the parent procedure marked with “optimization unnecessary”.

### BACKGROUND OF THE INVENTION

1. Field of the Invention

The present invention relates to a method and program for compiling processing to generate an object code with one time of compilation from source data such as a plurality of source program files (source files) or intermediate language codes which have been converted from the source files, and a recording medium for recording the compiling processing program.

2. Description of the Related Art

Large-scale application programs, in recent years, tend to be composed of a plurality of source files for efficiency of development because such programs are mainly created by collaboration of several stuff members. In addition, in order to structuralize an application program and to facilitate understanding of its entire structure easily, only a small number of functional units (e.g., procedures, variables, etc.) related deeply with each other tend to be described in individual files.

In this way, a large-scale application program has come to have more caller-callee relations among procedures extending over a plurality of files compared with that in the past. Thus, a compiling processing technique with an optimization function, which can execute even such a program at a high speed, is required.

A technique for analyzing a caller-callee relation extending over a plurality of files of a large-scale application program to utilize the relation in other optimization processing is called cross-file optimization. Conventionally, in the cross-file optimization, in the case where a plurality of source files are subjected to compiling processing, information representing a caller-callee relation between procedures is acquired in advance, and a code is generated, which subjected to optimization relating to procedures defined in sources based on this information of caller-callee relation at the time of compilation (e.g., see Japanese Patent Application Laid-Open No. 9-274570).

Conventionally, in order to perform the cross-file optimization, it is necessary to read all source files composing a program with one time of execution of compilation. This is the reason, in the case where a procedure A defined in a certain file and a procedure B defined in another file are in a caller-callee relation directly or indirectly, if information on processing performed in the procedure B at the time of compilation of the procedure A cannot be referred to, risks described below arise regardless of whether or not the procedure A and the procedure B are in a direct caller-callee relation:

1) It is possible that a global variable, which is defined or referred to in the procedure A, is defined or referred to also by the procedure B. In this case, optimization concerning all global variables used in the procedure A cannot be executed without the likelihood of having a wrong result.

2) Similarly, in the case where the procedure B is a procedure adopting a pointer as an argument, optimization cannot be executed without the likelihood of having a wrong result unless it is surely found that no area among memory areas to be used in the procedure A overlaps a pointer which is likely to be transferred to the procedure B.

Since the problems as described above may occur, it is necessary to give all pieces of source data together to a compiling process at the time of compilation in the conventional cross-file optimization.

However, there is a problem in that large-scale application programs or the like in recent years are too large to analyze all pieces of source data composing the program at a time, and compilation processing cannot be performed in a practical time.

### SUMMARY OF THE INVENTION

It is an object of the present invention to provide a program and method for causing a computer to execute compiling processing which, in the case where all pieces of source data composing a program are not given, automatically restrains optimization which is likely to cause a problem such as optimization for a global variable or optimization for a pointer and carries out optimization which can be performed safely, and a computer-readable medium recording the compiling processing program thereof.

The present invention is a program, method or apparatus for causing a computer to execute compiling processing for compiling a plurality of pieces of source data for a program with one time of execution of compilation, the program causing the computer to execute; inputting a plurality of pieces of source data for a program, subjecting the inputted source data to syntax analysis, analyzing an attribute of a caller-callee relation with other procedures defined in a procedure appearing in the inputted source data on the basis of the result of the syntax analysis and registering the analyzed attribute of the caller-callee relation of the procedure as procedure attribute information, marking the procedure the caller-callee relation of which is not registered in the procedure attribute information with “optimization unnecessary”, or subjecting the procedure the caller-callee relation of which is registered in the procedure attribute information to inline expansion, and optimizing the inputted source data excluding the caller-callee relation marked with “optimization unnecessary”.

In addition, the present invention is a computer-readable medium recording the program thereof.

The present invention acts as follows: inputting a plurality of source files for a certain program or intermediate language information corresponding to the source files; then, subjecting the inputted source data to syntax analysis; analyzing an attribute of a caller-callee relation with other procedures defined in a procedure appearing in the inputted source data from a result of the syntax analysis to store procedure attribute information; then, in performing inline expansion of source data, in the case where an attribute of a caller-callee relation which an appearing procedure calls in its inside is not included in the procedure attribute information, marking a procedure including the caller-callee relation with “optimization unnecessary” or, otherwise, subjecting the procedure the caller-callee relation of which is included in the procedure attribute information to inline expansion; and in optimizing source data, in the case where a procedure appearing in the source data is marked with “optimization unnecessary”, restraining optimization of the procedure and optimizing procedures other than the procedure to output an object code.

In the present invention, all pieces of source data are not inputted as a compilation target in the case of compilation, whereby, in the case where information on definition/reference of a procedure call which a certain procedure performs in its inside is unclear, inline expansion and optimization are not performed assuming that information on the call of the procedure is incomplete.

Consequently, it is unnecessary to input all pieces of source data composing a large-scale program as in the past, and only source data selected based upon procedure frequency information such as the number of times of execution of a procedure or user designated information can be set as a compilation target.

Therefore, it becomes possible to selectively input source data including a procedure with the large number of times of execution and subject only a part of a program with high execution frequency to compiling processing in a practical processing time. In addition, it becomes possible to selectively input source data including a character string, which a user has arbitrarily designated, and subject only a part of the program concerning a specific application to compiling processing in a practical processing time.

### BRIEF DESCRIPTION OF THE DRAWINGS

In the accompanying drawings:

FIG. 1 is a diagram showing an example of a system configuration in an embodiment of the present invention;

FIG. 2 is a diagram showing an example of an internal structure of a compiling processing program (a compiler);

FIGS. 3A to 3C are diagrams showing examples of a code of a source file;

FIG. 4 is a diagram showing an example of profile information;

FIG. 5 is a diagram showing an example of a procedure attribute table;

FIG. 6 is a flowchart showing a processing flow of source data input processing;

FIG. 7 is a flowchart showing a processing flow of inline expansion processing;

FIG. 8 is a diagram showing an image of source data of a source file prog.c subjected to inline expansion;

FIG. 9 is a flowchart showing a processing flow of optimization processing;

FIG. 10 is a flowchart showing a processing flow of object code output processing; and

FIGS. 11A and 11B are diagrams showing an image of source data after conventional inline expansion and an image of source data after conventional optimization.

### DETAILED DESCRIPTION OF THE PREFERRED EMBODIMENTS

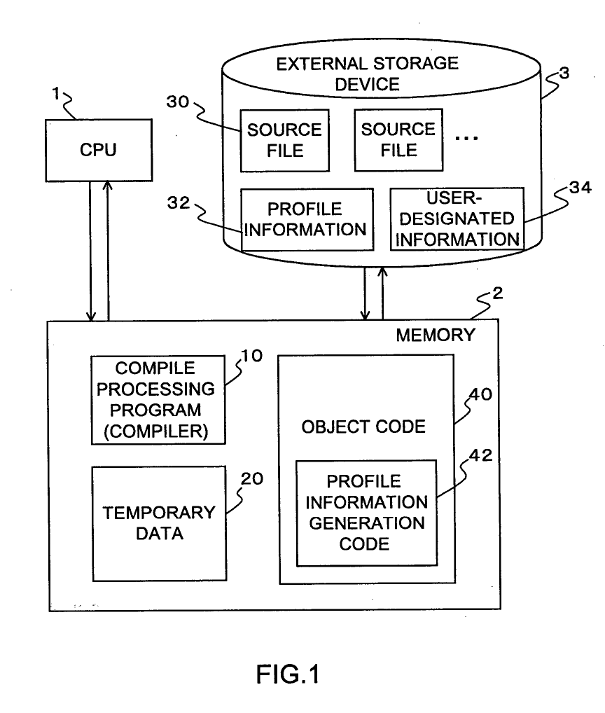

FIG. 1 shows an example of a system configuration in an embodiment of the present invention. A system embodying the present invention is composed of a CPU 1, a memory 2, and an external storage device 3.

A compiling processing program (compiler) 10 realizing the present invention, during one time of compilation, inputs source data selected from a plurality of source files 30 stored in the external storage device 3 or intermediate language data converted from the source files 30 along by profile information 32 or user-designated information 34, executes compilation including optimization, and outputs an object code 40. The profile information 32 is execution history information of the object code 40, which is information generated by a profile information generation code 42 outputted by the compiler 10 together with the object code 40. The user-designated information 34 is information to be a reference for selecting source data set by a user through an input device (not shown in FIG. 1). Temporary data 20 is an area for temporarily storing data to be used by the compiler 10 such as the inputted source file 30, the profile information 32.

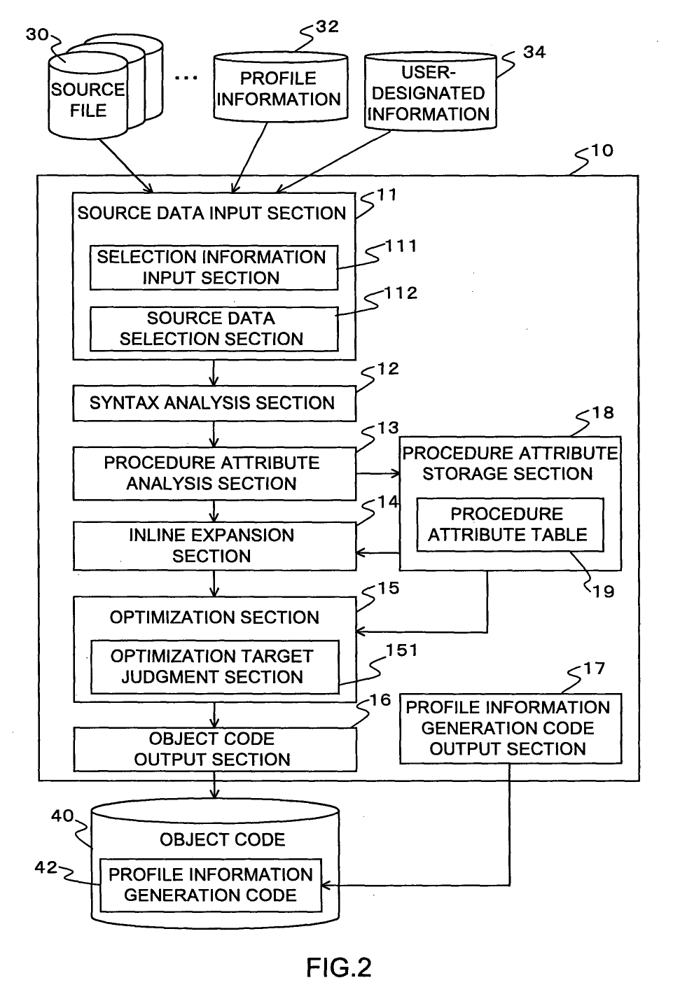

FIG. 2 shows an example of an internal structure of the compiling processing program (compiler) 10. The compiler 10 is provided with a source data input section 11, a syntax analysis section 12, a procedure attribute analysis section 13, an inline expansion section 14, an optimization section 15, an object code output section 16, a profile information generation code output section 17, and a procedure attribute storage section 18.

The source data input section 11 is means for inputting source data to be a target of compilation and is provided with a selection information input section 111 and a source data selection section 112. The selection information input section 111 is means for inputting the profile information 32 or the user-designated information 34 which is information (selection information) to be a reference in selecting source data to be inputted as a target of compilation from the source files 30 or the intermediate language data converted from the source files 30.

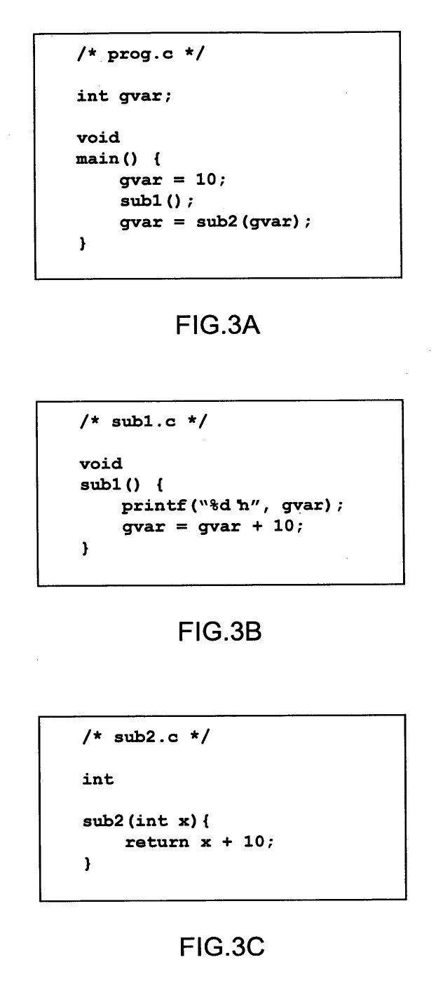

In this embodiment, the source files 30, which are described in the C language, stored in the external storage device 3 are assumed to be source data. File names of the source files 30 are assumed to be “prog.c”, “sub1.c”, and “sub2.c”, respectively. FIGS. 3A to 3C show examples of a code of a source file. FIG. 3A shows a code of a source file prog.c, FIG. 3B shows a code of a source file sub1.c, and FIG. 3C shows a code of a source file sub2.c.

The profile information 32 is execution history information in the case where source data is executed, and is generated according to the profile information generation code 42 included in the object code 40 generated by the compiler 10. The profile information 32 includes, for example, file names of the source files 30, a name of procedure to be executed in the source code, the number of basic blocks, the number of times of execution of each basic block, the number of branch instructions, the number of times of conclusion of each branch instruction, and the like. Here, the basic block means a fraction of a program to be executed in series without including branch processing in parts other than an end thereof.

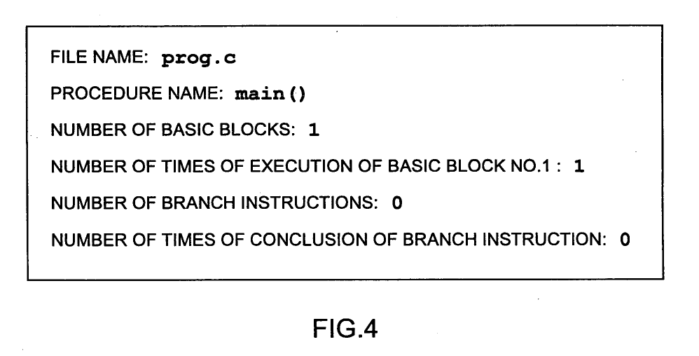

FIG. 4 shows an example of profile information of the source file prog.c. Since there is no branch or judgment processing and a series of procedure is one for the source file prog.c (see FIG. 3A), the profile information generation code 42 generates the profile information 32 including the number of basic blocks=1, the number of times of execution of a first basic block=1, and the like as content.

The user-designated information 34 is information designated by a user arbitrarily through an input device or the like. The user can designate a part of a character string of file names of the source files 30, a part of a character string of a described function, or the like as the user-designated information 34.

The source data selection section 112 is means for selecting a source file to be a target of compilation from the plurality of source files 30 stored in the external storage device 3 based upon the profile information 32 or the user-designated information 34. The source data selection section 112 selects the source files 30, for which the number of times of execution of basic blocks is equal to or more than a predetermined number of times, with reference to the profile information 32. Alternatively, the source data selection section 112 selects the source files 30 which include the character string designated in the user-designated information 34 in file names or procedure names.

The syntax analysis section 12 is means for analyzing syntaxes of the source files 30 inputted by the source data input section 11. The syntax analysis section 12 performs processing using known various methods of syntax analysis.

The procedure attribute analysis section 13 is means for extracting information on procedure attributes such as a type of an argument, a procedure being called in its inside (procedure call), and a global variable being defined or referred to in its inside (procedure attribute information) for each definition of a procedure appearing in the source files 30 based upon a result of the analysis of the syntax analysis section 12, and registering the information in a procedure attribute table 19.

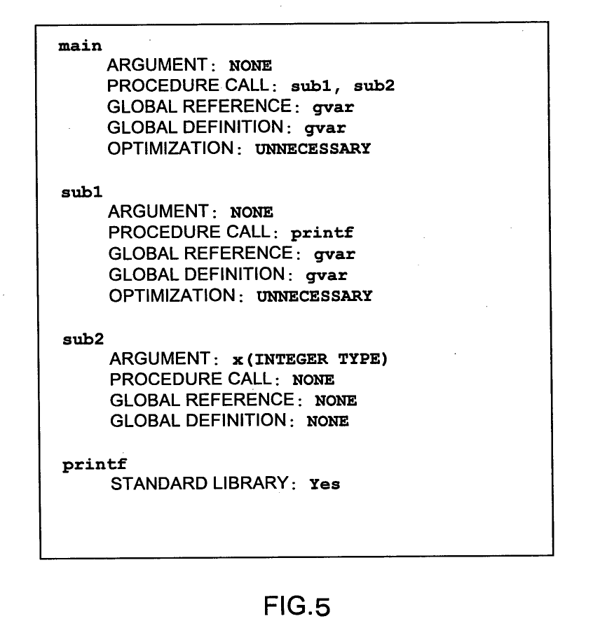

FIG. 5 shows an example of the procedure attribute table 19. Here, it is assumed that the source data input section 11 selects and inputs the three source files (prog.c, sub1.c, and sub2.c) shown in FIG. 3.

The procedure attribute analysis section 13 analyzes an argument of a procedure, a procedure call to be performed in the inside of the procedure, a global reference to be used, a global definition, and the like from each of procedures main, sub1, sub2, and printf included in these three source files 30, and registers them in the procedure attribute table 19. In addition, since printf is a standard library function of the C language, “standard library: yes” is registered.

Note that the procedure attribute table 19 may be adapted such that a standard function group (such as a standard library function, etc.) of a programming language, with which the source files 30 are described, is registered therein in advance.

The inline expansion section 14 is means for, with reference to the procedure attribute table 19, attaching a mark of “optimization unnecessary” to a procedure call, procedure attribute information of which is not registered in the procedure attribute table 19, among procedure calls performed in the inside of procedures appearing in the inputted source files 30 and, on the other hand, performing inline expansion for a procedure call, procedure attribute information of which is registered in the procedure attribute table 19 and which conforms to predetermined judgment criteria. As the predetermined judgment criteria, for example, information on complexity of procedure contents is used such as the number of times of execution of a procedure call, the number of instructions after the inline expansion of a procedure call, presence or absence of loop processing, or the number of times of repetition.

The optimization section 15 is means for performing optimization of respective procedures appearing in the source files 30 after the inline expansion and is provided with an optimization target judgment section 151. If there is a procedure call performed in the inside of a procedure, the optimization target judgment section 151 retrieves all procedures to be called directly or indirectly with reference to the procedure attribute table 19. Then, in the case where attribute information of the procedure call to be performed by the procedures is not registered in the procedure attribute table 19, the optimization section 15 restrains optimization for a global variable and a pointer in the procedures based upon a result of the retrieval of the optimization target judgment section 151.

The object code output section 16 is means for generating and outputting the object code 40 optimized from the source data. The profile information generation code output section 17 is means for, in the case where the profile information 32 is requested, outputting a processing code (profile information generation code) 42 for generating the profile information 32 so as to be formed in the inside of the object code 40. The procedure attribute storage section 18 is means for storing the procedure attribute table 19.

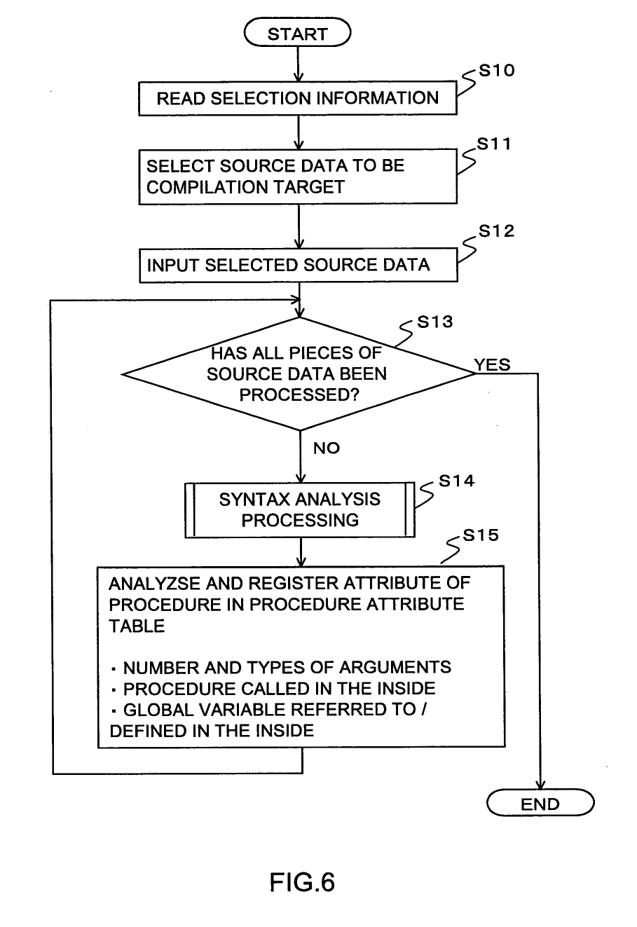

FIGS. 6 to 9 show a flow of processing of the present invention. FIG. 6 shows a processing flow of source data input processing.

The selection information input section 111 of the source data input section 11 checks whether or not there is selection information such as the profile information 32 or the user-designated information 34 corresponding to source data such as the source files 30 stored in the external storage device 3 and, if the selection information is stored, reads the selection information (step S10). Then, the source data selection section 112 selects source data to be a target of compilation based upon a basic block, a procedure, an execution frequency for each function of processing of the profile information 32, a character string of the source files 30 for which the user-designated information 34 is designated, and the like (step S11), and inputs the selected source data (step S12).

For example, it is assumed that the three source files 30 shown in FIGS. 3A to 3C are stored in the external storage device 3 as source data and character strings “prog” and “sub2” are designated by the user-designated information 34. The source data input section 11 retrieves through the external storage device 3 with the character strings “prog” and “sub2” of the user-designated information 34 as a search key, and extracts and inputs the source files prog.c and sub2.c as targets of compilation.

Thereafter, the compiler 10 applies processing of the following steps S14 and S15 to all pieces of source data (step S13). First, the syntax analysis section 12 performs syntax analysis processing (step S14). Then, the procedure attribute analysis section 13 analyzes attributes of procedures appearing in the source data, registers results of the analysis such as the number and types of arguments, a procedure call being performed in its inside, and a global variable being referred to or defined in its inside in the procedure attribute table 19 to store the results of the analysis in the procedure attribute storage section 18 (step S15).

Here, based upon the results of the analysis, the procedure attribute analysis section 13 registers attribute information of procedures main and sub2 appearing in prog.c and sub2.c in the procedure attribute table 19 with the same contents of registration as the procedure of the procedure attribute table 19 shown in FIG. 5.

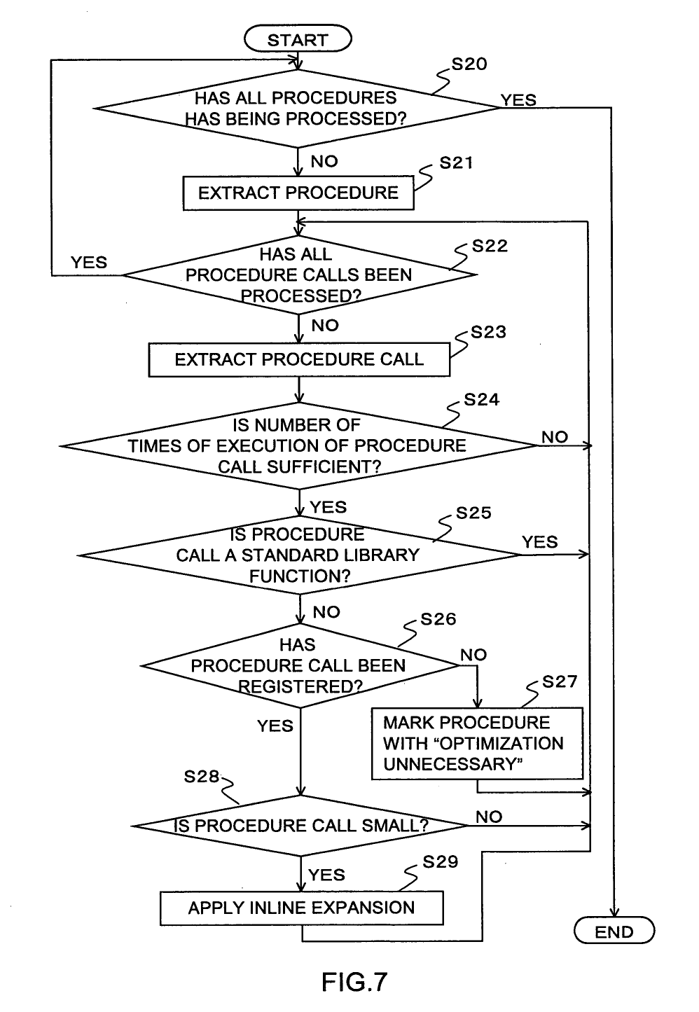

FIG. 7 shows a processing flow of inline expansion processing. The inline expansion section 14 performs processing of the following steps S21 to S29 for all procedures appearing in source data (step S20), and extracts one procedure (step S21), and applies processing of the following steps S23 to S29 to all procedure calls to be performed in its inside of the procedure (step S22).

First, the inline expansion section 14 extracts one procedure call (step S23) and judges whether or not the number of times of execution of the procedure call is sufficient with reference to the profile information 32 (step S24). If the procedure call has not been executed the sufficient number of times, the inline expansion section 14 returns to the processing of step S22 and extracts the next procedure call (step S23). On the other hand, if the procedure call has been executed the sufficient number of times, the inline expansion section 14 further judges whether or not the procedure call is a standard library function (step S25).

With reference to the procedure attribute table 19, if the procedure call is the standard library function, the inline expansion section 14 returns to the processing of step S22 and extracts the next procedure call (step S23). On the other hand, if the procedure call is not the standard library function, the inline expansion section 14 judges whether or not the procedure call has been registered in the procedure attribute table 19 (step S26). Then, if the procedure call is not registered in the procedure attribute table 19, the inline expansion section 14 marks a procedure for which the procedure call is performed with “optimization unnecessary” (step S27). The marking of “optimization unnecessary” is performed by setting “unnecessary” in an item of optimization for a pertinent procedure in the procedure attribute table 19. Alternatively, an optimization unnecessary procedure table (not shown) is separately provided, and the marking of “optimization unnecessary” is performed by adding a procedure which is not optimized in this optimization unnecessary procedure table.

On the other hand, if the procedure call is registered in the procedure attribute table 19, the inline expansion section 14 judges whether or not the number of instructions after the inline expansion is sufficiently small using a known inline expansion estimation function (step S28). If the number of instructions for the procedure call is sufficiently small even after the inline expansion, the inline expansion section 14 subjects the procedure call to the inline expansion (step S29). In addition, if the number of instructions for the procedure call is not sufficiently small after the inline expansion, the inline expansion section 14 returns to the processing of step S22 and extracts the next procedure call (step S23).

The inline expansion section 14 repeats the above-described processing to process all the procedure calls (step S22) and, upon processing all the procedures, ends the inline expansion processing.

Here, first, the inline expansion section 14 extracts the source file “prog.c” and extracts the procedure “main.” Then, the inline expansion section 14 extracts the item of the procedure main from the procedure attribute table 19 and refers to the following:

Argument: none

Procedure call: sub1, sub2

Global reference and global definition: gvar.

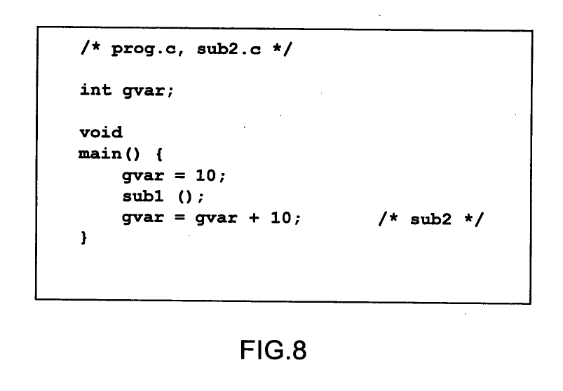

Then, as a result of retrieving through the procedure attribute table 19 with the procedure calls sub1 and sub2 as a search key, since sub1 is not registered, the inline expansion section 14 adds “optimization: unnecessary” in the item of the procedure main of the procedure attribute table 19. Subsequently, since the procedure sub2 is registered in the procedure attribute table 19, the inline expansion section 14 subjects the procedure sub2 to the inline expansion. FIG. 8 shows a source data image of the source file prog.c subjected to the inline expansion.

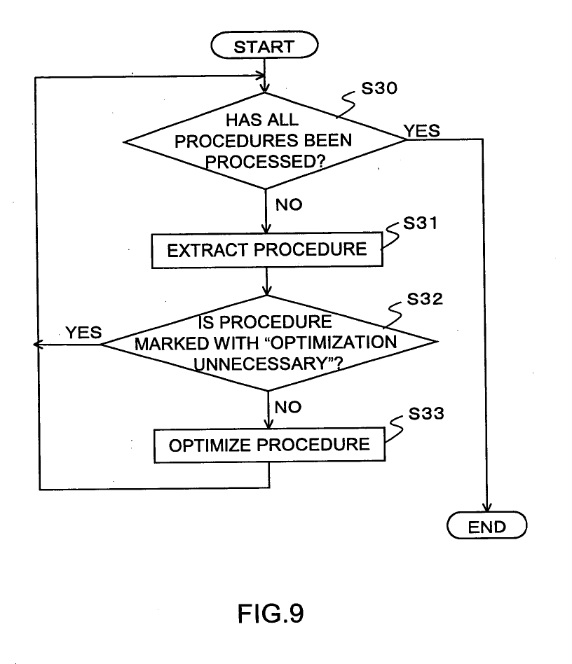

FIG. 9 shows a processing flow of optimization processing. The optimization section 15 applies processing of the following steps S31 to S33 to all procedures (step S30).

First, the optimization section 15 extracts one procedure (parent procedure) (step S31). Then, the optimization target judgment section 151 judges whether or not the procedure is marked with “optimization unnecessary” with reference to the procedure attribute table 19 (step S32). If the procedure is not marked with “optimization unnecessary”, the optimization section 15 optimizes the procedure (step S33). If the procedure is marked with “optimization unnecessary”, the optimization section 15 returns to the processing of step S30 without performing optimization. Then, if the processing has been performed for all the procedures, the optimization section 15 ends the optimization processing.

Here, since “optimization: unnecessary” is set in the item of the procedure main of the procedure attribute table 19, the optimization section 15 does not perform optimization for the procedure main of the source data of the contents shown in FIG. 8.

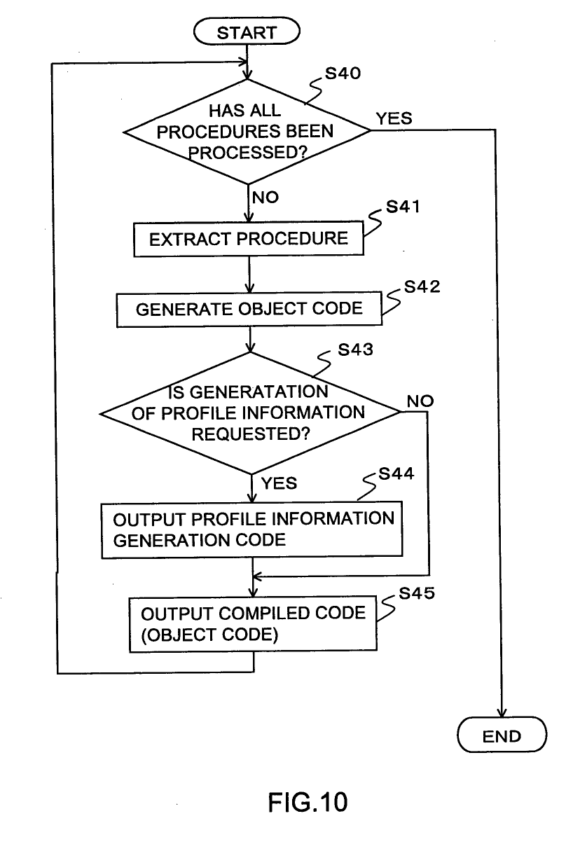

FIG. 10 shows a processing flow of object code output processing. The object code output section 16 performs processing of the following steps S41 to S45 for all procedures (step S40).

First, the object code output section 16 extracts one procedure (step S41) and generates an object code 40 (step S42). Then, if generation of the profile information 32 has been requested (step S43), the object code output section 16 generates and outputs the profile information generation code 42 with the profile information generation code output section 17 (step S44). Thereafter, the object code output section 16 outputs a compiled code (object code) (step S45). Here, the object code 40 including the source data image shown in FIG. 8 as contents is outputted.

Consequently, it becomes possible to exclude the source files 30 concerning a procedure with the small number of times of execution by a unit of basic block such as an error processing routine from a target of compilation and to subject only a part with high execution frequency of a program to compiling processing in a practical processing time. In addition, by selectively inputting the source files 30 including a character string designated by a user arbitrarily, it becomes possible to subject only a part concerning a specific application of a program to compiling processing in a practical processing time.

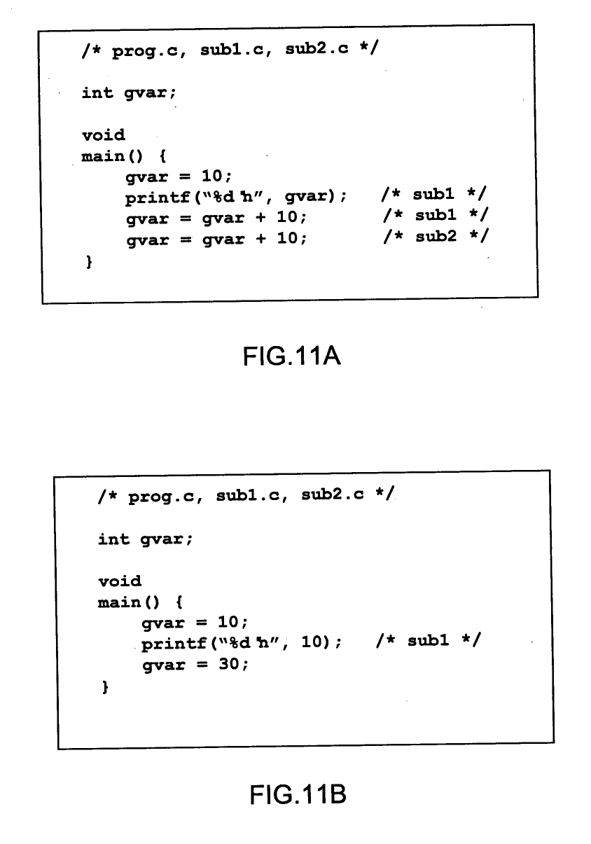

For comparison of the processing of the present invention and the conventional technique, FIG. 11A shows a source data image after the conventional inline expansion for the source data shown in FIG. 3, and FIG. 11B shows a source data image after the conventional optimization. As it is evident from comparison of the source data image subjected to compilation processing according to the present invention shown in FIG. 8 and the conventional source data image subjected to compilation processing shown in FIG. 11B, a result of optimization according to the present invention has a low degree of optimization compared with the conventional cross-file optimization.

However, in the present invention, it becomes possible to apply compilation processing even to a application program formed of enormous source data in a practical time. In addition, in the present invention, since arbitrary pieces of source data are combined to be a target of compilation, only source data of a specific application can be set as a target of processing, and it becomes possible to perform efficient compilation processing.

For example, in a hardware performance evaluation program, in the case where only specific data designated for each evaluation is executed, since it is sufficient to set source data concerning the specific data as a target of compilation, practical and efficient compiling processing can be performed by applying the present invention. In addition, in a printer control program provided with functions of both monochrome printing and color printing, again, by applying the present invention, practical and efficient compiling processing can be performed with only source data concerning frequently used monochrome print control as a target of compilation.

The present invention has been described according to the embodiment thereof. However, it is natural that the present invention can be modified in various ways within the scope thereof. In this embodiment, the present invention is described with the case where a relation between a procedure appearing in source data and a procedure call to be performed in the inside of the procedure is one layer as an example. However, in the case where, in a procedure call (referred to as “child procedure”) in a procedure (referred to as “parent procedure”), there is a procedure call to be performed in the inside of the child procedure (referred to as “grandchild procedure”), a relation between the child procedure and the grandchild procedure is treated in the same manner as a relation between the parent procedure and the child procedure to perform processing.

In addition, in this embodiment, the inline expansion section 14 is described as performing processing according to the processing flow as shown in FIG. 7. However, the inline expansion section 14 may be any section as long as it executes at least the judgment processing shown in step S26 in the processing shown in FIG. 7. The inline expansion section 14 is also capable of performing inline expansion without executing, for example, the processing of steps S24 and S28 and is also capable of performing inline expansion using known judgment processing other than the judgment processing described in this embodiment.

Note that means, elements, or functions in accordance with the present invention can be realized as a program which is read and executed by a computer. In addition, the program realizing the present invention can be stored in an appropriate computer readable recording medium such as a portable media memory, a semiconductor memory, or a hard disk. The program is recorded in the recording medium and provided, or provided by transmission and reception utilizing various communication networks via a communication interface.

As described above, according to the present invention, only arbitrary source data is set as a target of compilation out of source data consisting of a plurality of files forming a application program based upon profile information, in which the number of times of execution of a procedure or the like is recorded, or user designated information, in which a user designates a specific application or the like with a character string. Then, attribute information concerning a caller-callee relation such as a global definition or a global reference of a procedure call, which is performed by a procedure appearing in the source data in its inside, is stored. If attribute information such as definition or reference of a procedure call, which is performed in the inside of the procedure appearing in the source data at the time of inline expansion, is unclear, inline expansion for the procedure call is not performed in the procedure and, moreover, optimization of the procedure including the procedure call, attribute information of which is unclear, is not performed at the time of optimization.

In the conventional compiling processing, since it is necessary to make all pieces of attribute information of a caller-callee relation complete in inline expansion and optimization, it is necessary to input all pieces of source data forming a large-scale program.

However, in the present invention, since it is possible to restrain inline expansion and optimization for a caller-callee relation, attribute information of which is incomplete, it is unnecessary to input all pieces of source data forming a program. Therefore, a compiling processing program for causing a computer to execute compiling processing which is capable of performing processing in a practical processing time according to a compiling processing environment, a compiling processing method, and a compiling processing program recording medium can be provided.

In particular, only source data, which is selected based upon procedure frequency information such as the number of times of execution of a procedure and user designated information, can be set as a target of compilation, and it becomes possible to selectively execute compilation of only a part with high frequency of execution of a program or a part concerning a specific application of a program. Therefore, a compiling processing program for causing a computer to execute compiling processing which is capable of performing efficient processing, a compiling processing method, and a compiling processing program recording medium can be provided.

What is claimed is:

1. A program for causing a computer to execute compiling processing for compiling a plurality of pieces of source data composing a program with one time of execution of compilation, the program causing the computer to execute:
inputting a plurality of pieces of source data for a program;
subjecting the inputted source data to syntax analysis;
analyzing an attribute of a caller-callee relation with other procedures defined in a procedure appearing in the inputted source data on the basis of the result of the syntax analysis and registering the analyzed attribute of the caller-callee relation of the procedure as procedure attribute information;
marking the procedure the caller-callee relation of which is not registered in the procedure attribute information with “optimization unnecessary”, or subjecting the procedure the caller-callee relation of which is registered in the procedure attribute information to inline expansion; and
optimizing the inputted source data excluding the caller-callee relation marked with “optimization unnecessary”.

2. The program according to claim 1, wherein the processing program further causing the computer to execute:
inputting and storing user-designated information in which a plurality of pieces of source data composing a program are designated as a target of compilation,
whereby the plurality of pieces of source data to be inputted was selected on the basis of the user-designated information.

3. The program according to claim 1, wherein the program causes the computer to execute:
inputting execution history information of the object code, and
whereby the plurality of pieces of source data to be inputted was selected on the basis of the execution history information.

4. A method of processing a plurality of pieces of source data composing a program with one time of execution of compilation, the method comprising the steps of:
inputting a plurality of pieces of source data for a program;
subjecting the inputted source data to syntax analysis;
analyzing an attribute of a caller-callee relation with other procedures defined in a procedure appearing in the inputted source data on the basis of the result of the syntax analysis and registering the analyzed attribute of the caller-callee relation of the procedure as procedure attribute information;
marking the procedure the caller-callee relation of which is not registered in the procedure attribute information with “optimization unnecessary”, or subjecting the procedure the caller-callee relation of which is registered in the procedure attribute information to inline expansion; and
optimizing the inputted source data excluding the caller-callee relation marked with “optimization unnecessary”.

5. The method according to claim 4, comprising the steps of:
input processing for inputting and storing user-designated information in which a plurality of pieces of source data composing a program are designated as a target of compilation, and
whereby the plurality of pieces of source data to be inputted was selected on the basis of the user-designated information.

6. The method according to claim 4, comprising the steps of:
inputting execution history information of the object code, and
whereby the plurality of pieces of source data to be inputted was selected on the basis of the execution history information.

7. A computer-readable medium recording therein a program for causing a computer to execute compiling processing for processing a plurality of pieces of source data for a program with one time of execution of compilation, the program causing the computer to execute:
inputting a plurality of pieces of source data composing a program;
subjecting the inputted source data to syntax analysis;
analyzing an attribute of a caller-callee relation with other procedures defined in a procedure appearing in the inputted source data on the basis of the result of the syntax analysis and registering the analyzed attribute of the caller-callee relation of the procedure as procedure attribute information;
marking the procedure the caller-callee relation of which is not registered in the procedure attribute information with “optimization unnecessary”, or subjecting the procedure the caller-callee relation of which is registered in the procedure attribute information to inline expansion; and
optimizing the inputted source data excluding the caller-callee relation marked with “optimization unnecessary”.

8. The computer-readable medium according to claim 7, wherein the processing program further causing the computer to execute:
inputting and storing user-designated information in which a plurality of pieces of source data composing a program are designated as a target of compilation, and
whereby the plurality of pieces of source data to be inputted was selected on the basis of the user-designated information.

9. The computer-readable medium according to claim 7, wherein the program causes the computer to execute:
inputting execution history information of the object code, and
whereby the plurality of pieces of source data to be inputted was selected on the basis of the execution history information.

10. An apparatus for processing a plurality of pieces of source data composing a program with one time of execution of compilation, the apparatus comprising:
means for inputting a plurality of pieces of source data for a program;
means for subjecting the inputted source data to syntax analysis;
means for analyzing an attribute of a caller-callee relation with other procedures defined in a procedure appearing in the inputted source data on the basis of the result of the syntax analysis and registering the analyzed attribute of the caller-callee relation of the procedure as procedure attribute information;
means for marking the procedure the caller-callee relation of which is not registered in the procedure attribute information with “optimization unnecessary”, or subjecting the procedure the caller-callee relation of which is registered in the procedure attribute information to inline expansion; and
means for optimizing the inputted source data excluding the caller-callee relation marked with “optimization unnecessary”.

11. The apparatus according to claim 10, comprising:
means for inputting and storing user-designated information in which a plurality of pieces of source data composing a program are designated as a target of compilation, and
whereby the plurality of pieces of source data to be inputted was selected on the basis of the user-designated information.

12. The method according to claim 4, comprising the steps of:
means for inputting execution history information of the object code, and
whereby the plurality of pieces of source data to be inputted was selected on the basis of the execution history information.
